(19) United States
(12) Patent Application Publication
(10) Pub. No.: US 2002/0052796 A1
(43) Pub. Date: May 2, 2002

(54) Method and system for providing services

(76) Inventors: Mitsuyoshi Tadokoro, Sagamihara (JP); Yuko Izumi, Isehara (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(21) Appl. No.: 09/888,259

(22) Filed: Jun. 21, 2001

(30) Foreign Application Priority Data
Oct. 27, 2000 (JP) P2000-329719

(51) Int. Cl. G06F 17/60

(52) U.S. Cl. 705/26

(57) ABSTRACT

The present invention provides techniques for allowing a user access to a plurality of services through a common access point. A service providing system includes the common access point and allows the user access with, for example, one user identifier (ID) and password. The user then requests a specific service and the service providing system, if it does not have the specific service, manages access to another service providing system to provide the specific service to the user. The services provided may be common or segregated by a criteria, such as area. For example a user in a certain area may receive services from service providers in his/her area.

### CROSS-REFERENCES TO RELATED APPLICATIONS

This application is related to and claims priority from Japanese Patent Application No. 2000-329719, filed on Oct. 27, 2000.

### BACKGROUND OF THE INVENTION

The present invention relates generally to electronic commerce over a communications network, for example, the Internet, and more particularly to providing a user a common access point to a plurality of services, some of which are segregated by location.

In recent years, there have appeared many sites that provide various services through their Internet WWW (World Wide Web) servers. Each user accesses those WWW servers via a WWW client so as to receive the services. To access a WWW server that provides commercial services, each user is requested to make a contract with a service company that runs the subject WWW server so as to be given a user ID and a password before he/she can uses the service.

A service provider of these services provided on the WWW, when permitting a user to use a service, often requests the user to send his/her personal information. This is to monitor whether or not the provided service is used in accordance with the contracted access condition and/or whether or not the service is used legally. Where there is a charge for the service, the provided service is monitored so as to calculate how much the user should be charged. Sometimes, the state of the user who is accessing the WWW server is monitored so as to use the results of the monitoring for market research. In these cases, each user, when he/she wants to access a service of a server, has been required to send his/her personal information to the server.

The conventional technique is burdensome to a user, since the user must register himself/herself in each server before using a service provided therefrom. The user is also forced to manage a pair of user ID and password for each time he/she registers to use a service. Thus, the more the user increases the number of services he/she uses, the more the user is forced to remember and manage his/her user IDs and passwords. Also the passwords may consist of incoherent alphanumerics further increasing the memory burden on the user. Consequently, the more the WWW comes to provide various useful services, the more the users' inconvenience is increased. In addition, users have come to feel uneasy about the diversion of their personal information, since their personal information is now held in servers around the world. These problems have been a bottle-neck for promoting information service markets on the WWW.

This bottleneck has adversely affected service providers, because the deepest interest of service providers is how to obtain more users, since the service providers make profits only from charges from their service users.

Thus there is a need to reduce the burden on the user in accessing services and hence increasing the opportunity of service providers in obtaining more users.

### SUMMARY OF THE INVENTION

The present invention provides techniques for allowing a user access to a plurality of services through a common access point. A service providing system includes the common access point and allows the user access with, for example, one user identifier (ID) and password. The user then requests a specific service and the service providing system, if it does not have the specific service, manages access to another service providing system to provide the specific service to the user. The services provided may be common or segregated by a criteria, such as area. For example a user in a certain area may receive services from service providers in his/her area. In one embodiment the secondary service providing company sees only the common access service providing company as its user. Thus, the actual user is shielded from the secondary service providing company by the common access service providing company.

One embodiment of the present invention provides a method for a user to use a plurality of services through a common access point. The method includes, comprising: providing the user access to a first computer system. Next, responsive to a user request for a service of, the first computer system accesses a second computer system, having the service; and then the service is provided to said user from the second computer system via the first computer system.

A second embodiment of the present invention provides a service providing system for providing a service located on a computer system to a user. The user need only access the service providing system to obtain the service. The computer system is coupled to the service providing system via a communications network, for example, the Internet or an intra-net. The service providing system includes: a storage system; an access table stored in a first part of said storage system, having a user identification for access to the service providing system by the user; a mapping table stored in a second part of the storage system, having the user identification and associated login information, where the associated login information is for access by the service providing system to the service; and responsive to a request by the user for the service, software stored in a third part of the storage system for accessing the computer system using said login information and for obtaining the service for the user. The storage system may be one memory or a plurality of memories of volatile or non-volatile type or a mixture of volatile and non-volatile type memories.

Another embodiment of the present invention provides a service providing method for connecting a plurality of service providing systems to a service access apparatus via a communication network so as to enable each of those service providing systems to provide various services to the service access apparatus. The method has the steps of: sending display data including an indication for a service request to a second service providing system when a first service providing system provides a service to the service access apparatus; specifying a service request to be issued to the second service providing system in the display data displayed on the screen of the service access apparatus so as to enable the service access apparatus to request a service of the second service providing system, for example, the indication is selected by the user; starting communication between the service access apparatus and the second service providing system via the first service providing system so as to provide the service of the second service providing system to the service access apparatus.

One embodiment of the present invention enables the first service providing system to hold a preset anonymous user ID used to log in the second service providing system, so that the first service providing system, when the service access apparatus issues a service request to the second service providing system, establishes communication with the second service providing system with use of the anonymous user ID.

Another embodiment of the present invention provides a service providing system for providing various services to a service access apparatus via a communication network. The service providing system has: a module for sending display data including a user selection for a service request from a second service providing system when it provides a service to the service access apparatus; a module for establishing communication with the second service providing system when the display data displayed on the screen of the service access apparatus is used to specify a service request to be issued to the second service providing system; and a module for relaying the communication between the second service providing system and the service access apparatus so as to enable the second service providing system to provide the service to the service access apparatus.

The above embodiments of the service providing system may further include: a module for holding a preset anonymous user ID used to log in the second service providing system; and a module for establishing the communication with the second service providing system with use of the anonymous user ID when the service access apparatus issues a service request to the second service providing system.

In one embodiment of the present invention a distributed system provides a plurality of services to a plurality of users. The system includes: a central server for providing a common access point for the plurality of users to the plurality of services; a plurality of area servers coupled to said central server for providing information on local services of said plurality of services to local users of said plurality of users; and a plurality of local cooperated company servers having said local services and coupled to said plurality of area servers. The process includes a local user accessing the central server with a user request for a local service. The central server sends the request to a area server within the users area, for example, telephone area code, and the area server obtains the local service for said local user. The area server has a mapping of local anonymous users to local users for access to local cooperated company servers having local services. The area servers are franchise servers of the central server. Thus, users have a common access point, hence one user ID and password to remember, but have access to common and local services. In addition the local service provider, for example, a small local business, may easily reach his/her local customer base.

These and other embodiments of the present invention are described in more detail in conjunction with the text below and attached figures.

### BRIEF DESCRIPTION OF THE DRAWINGS

FIG. 1 is a block diagram of a service providing system in an embodiment of the present invention.

FIG. 2 is a block diagram of a service providing system of a cooperated company in an embodiment of the present invention.

FIG. 3 is block diagram of a service access apparatus in an embodiment of the present invention.

FIG. 4 is a block diagram of a network in one embodiment of the present invention.

FIG. 4-1 is a block diagram of a network in an another embodiment of the present invention.

FIG. 5 is a configuration of user information stored in a data memory of a service providing system of an embodiment of the present invention.

FIG. 6 is a configuration of service information classified by user, stored in the data memory of the service providing system of an embodiment of the present invention.

FIG. 7 is a configuration of substitute user information stored in the data memory of the service providing system of an embodiment of the present invention.

FIG. 8 is a configuration of common information of state, stored in the data memory of the service providing system of an embodiment of the present invention.

FIG. 9 is a configuration of information of state classified by area, stored in the data memory of the service providing system of an embodiment of the present invention.

FIG. 10 is user information of a cooperated company stored in the data memory of the service providing system of a cooperated company of an embodiment of the present invention.

FIG. 11 is a display example (1) of a service access screen.

FIG. 12 is a display example (2) of the service access screen.

FIG. 13 is a display example (3) of the service access screen.

FIG. 14 is a display example (4) of the service access screen.

FIG. 15 is a display example (5) of the service access screen.

FIG. 16 is a display example (6) of the service access screen.

FIG. 17 is a display example (7) of the service access screen.

FIG. 18 is an example of a processing flow of an embodiment of the present invention.

FIG. 19 is a flowchart of the management of common service.

FIG. 20 is a flowchart of the management of service classified by area of an embodiment of the present invention.

FIG. 21 is a flowchart of the substitute replay processing of an embodiment of the present invention.

FIG. 22 is a flowchart of a synchronization processing of an embodiment of the present invention.

FIG. 23 is a flowchart of the management of common service announcement of an embodiment of the present invention.

FIG. 24 is a flowchart of the management of service announcement classified by area of an embodiment of the present invention.

FIG. 25 is a flowchart of the management of service classified by area, executed by the service providing system of cooperated company 201 of an embodiment of the present invention.

### DESCRIPTION OF THE SPECIFIC EMBODIMENTS

Hereunder, the preferred embodiments of the present invention will be described with reference to the accompanying drawings.

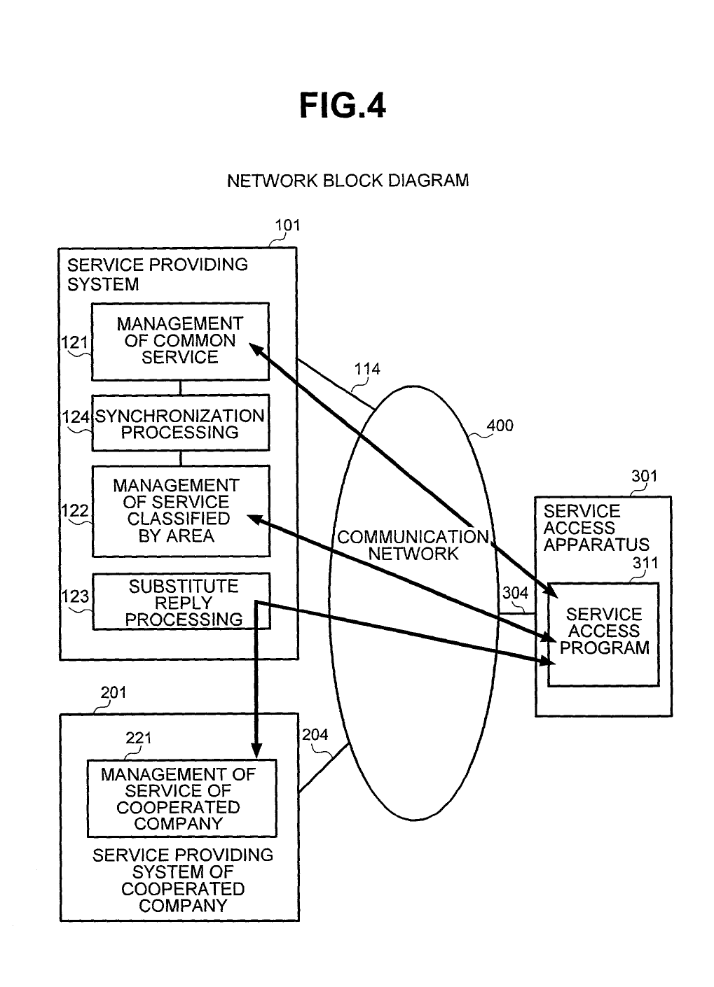

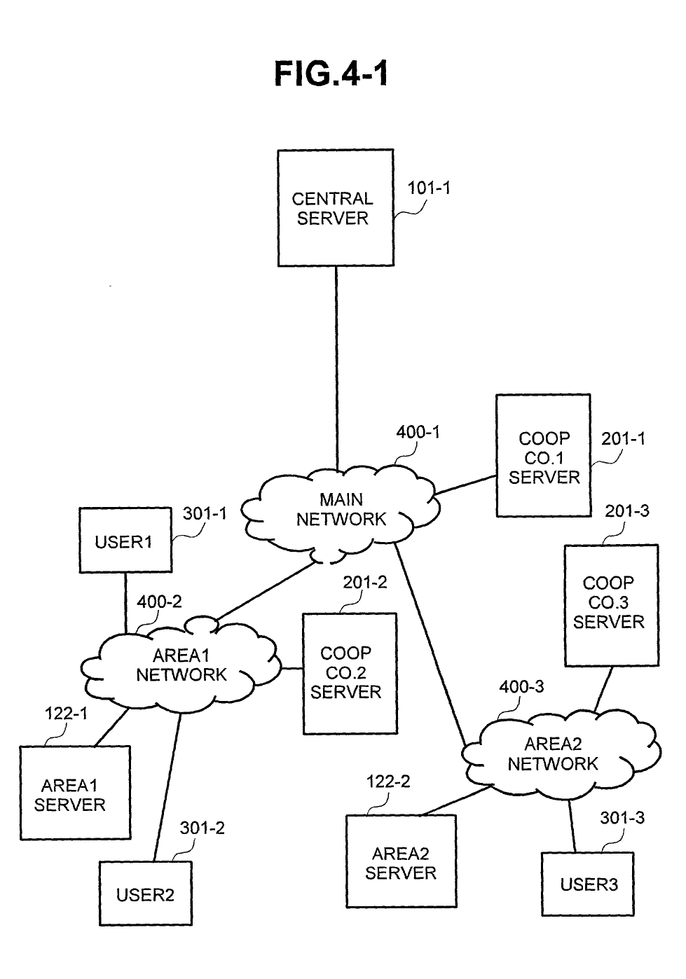

At first, a description will be made for a configuration of a network as shown in FIG. 4 (to be described later) in which: a service providing system 101; a service providing system 201 of a cooperated company; and a service access apparatus 301 are connected to a communication network 400.

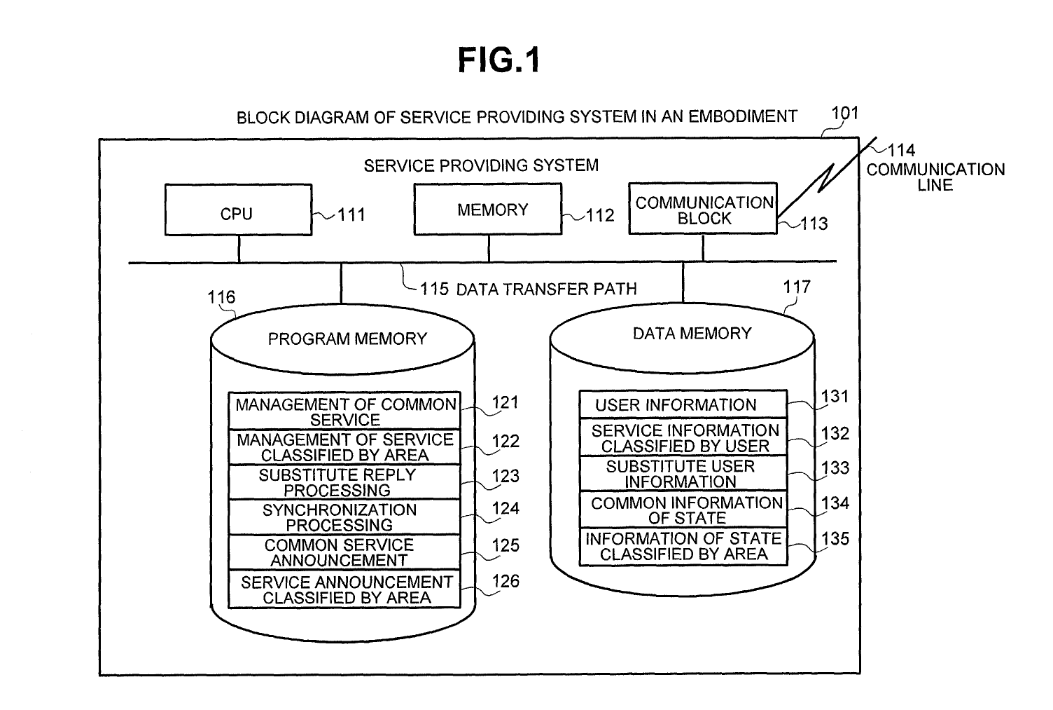

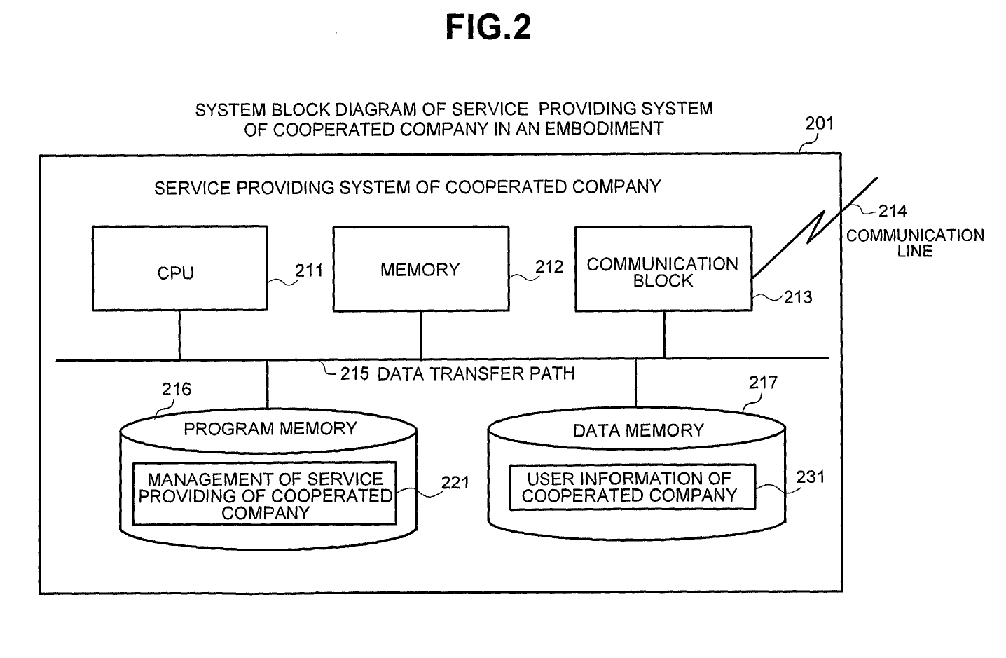

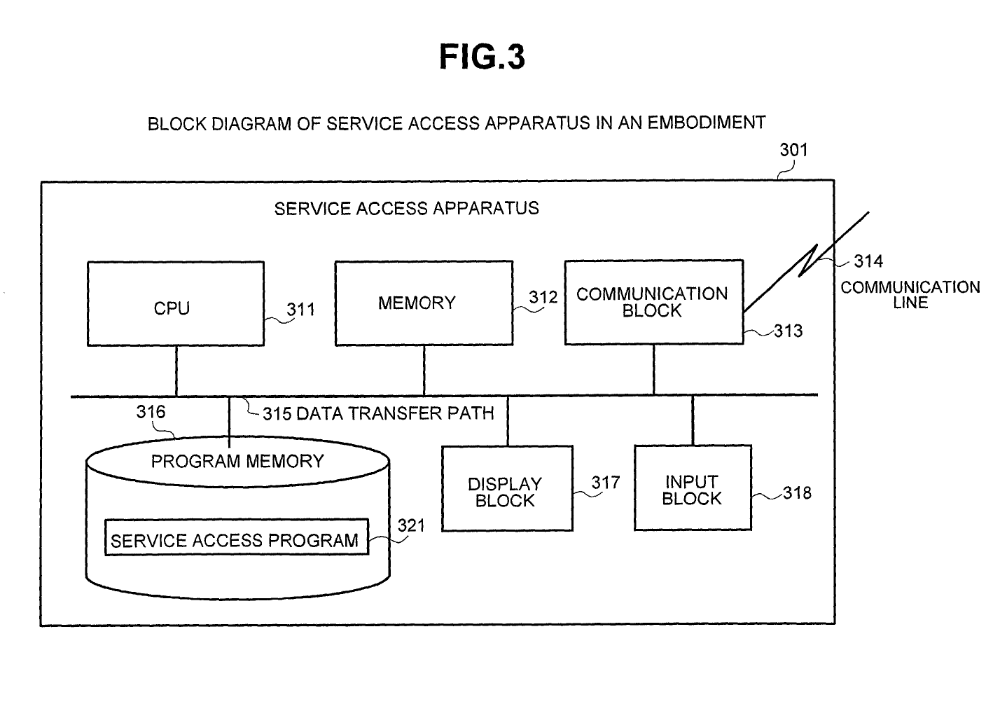

FIG. 1 is a block diagram of the service providing system 101. FIG. 2 is a block diagram of the service providing system 201 of a cooperated company. FIG. 3 is a block diagram of the service access apparatus 301, for example, a user's personal computer (PC), or a cell phone, or a Personal Digital Assistant (PDA).

Hereinafter, the configuration of the service providing system 101 will be described with reference to FIG. 1. The service providing system 101 provides various services to the users via a communication network.

The service providing system 101 includes a CPU 111; a memory 112; a communication block 113; a data transfer path 115; a program memory 116; and a data memory 117. The CPU 111 is a central processing unit for controlling the whole service providing system 101. The memory 112 is a storage device for storing various processing programs loaded from a non-volatile program memory 116 so as to execute them and storing other various data. The communication block 113 is an interface connected to a communication line 114. The communication block 113 enables the service providing system 101 to communicate with other systems and apparatuses via a communication network. The data transfer path 115 is a bus line connected to each of the components.

The program memory 116 stores various processing programs to be executed by the CPU 111. In particular, the program memory 116 stores the programs for: management of common service 121; management of service classified by area 122; substitute replay processing 123; synchronization processing 124; management of common service announcement 125; and management of service announcement classified by area 126. Each of those programs is loaded into the memory 112 when it is executed. In the following description, however, a program loaded into the memory 112 and being executed is also referred to as a number within 121 to 126. The data memory 117 is a secondary storage device for storing various data to be used by the service providing system 101. In particular, the data memory 117 stores items of: user information 131; service information classified by user 132; substitute user information 133; common information of state 134; and information of state classified by area 135. Each processing program stored in the program memory 116 and each information stored in the data memory 117 will be detailed later.

The configuration of the service providing system of a cooperated company 201 will be described with reference to FIG. 2. The service providing system of cooperated company 201, just like the service providing system 101, provides various services to the users, especially via the service providing system 101.

The service providing system of cooperated company 201 includes: a CPU 211; a memory 212; a communication block 213; a data transfer path 215; a program memory 216; and a data memory 217. The CPU 211 is a central processing unit for controlling the whole service providing system 201. The memory 212 is a storage device for storing various processing programs loaded from a program memory 216, which is a secondary storage device, so as to execute them and storing various other data. The communication block 213 is an interface connected to a communication line 214. The communication block 213 enables the service providing system of cooperated company 201 to communicate with other systems and apparatuses via a communication network. The data transfer path 215 is a bus line connected to each of the components.

The program memory 216 is a secondary storage device for storing various processing programs to be executed by the CPU 211, and particularly stores a program for management of service of cooperated company 221. The program is loaded into the memory 212 when it is executed. In the following description, however, the program loaded into the memory 212 and being executed is also referred to as a number of 221. The data memory 217 is a secondary storage device for storing various data to be used by the service providing system of cooperated company 201, and particularly stores user information of cooperated company 231. Each processing program stored in the program memory 216 and each information stored in the data memory 217 will be detailed later.

The configuration of the service access apparatus 301 will be described with reference to FIG. 3. The service access apparatus 301 is used by each user so as to access his/her desired services.

The service access apparatus 301 includes: a CPU 311; a memory 312; a communication block 313; a data transfer path 315; a program memory 316; a display block 317; and an input block 318. The CPU 311 is a central processing unit for controlling the whole service providing system 301. The memory 312 is a storage device for storing various processing programs loaded from a program memory 316, which is a secondary storage device, so as to execute them and storing various other data. The communication block 313 is an interface connected to a communication line 314. The communication block 313 enables the service access apparatus 301 to communicate with other systems and apparatuses via a communication network. The data transfer path 315 is a bus line connected to each of the components.

The program memory 316 is a secondary storage device for storing various processing programs to be executed by the CPU 311, and particularly stores a service access program 321, for example, a Web browser, such as Netscape® or Microsoft® Internet Explorer. In the following description, the service access program loaded into the memory 312 and being executed is also referred to as a number of 321. The display block 317 displays various information according to each instruction received from the CPU 311. The input block 318 is such an input device as a keyboard and a mouse used by the user to enter various data items. The program stored in the program memory 316 will be detailed later.

FIG. 4 is a block diagram of a network used by the systems in this embodiment. The service providing system 101, the service providing system of cooperated company 201, and the service access apparatus 301 are connected to the communication network 400. The communication network 400 is, for example, the Internet.

Each user, who is a customer of services provided by the systems in this embodiment can access the service providing system 101 by executing the service access program 311, e.g. browser, in his/her service access apparatus so as to receive a desired service therefrom. In this case, it is premised that the user has already obtained a user code (user ID) and a password in response to his/her personal information sent to and registered in the service providing system 101 before he/she accesses the service therefrom 101.

The service providing system 101 executes the management of common service 121, thereby providing a requested common service to the user. A common service is, for example, a service provided to all the users commonly; it is one of the services provided to the users from the service providing system 101. For example, the common service is a service for providing travel information to a user and accepting an application for the travel from the user. The service providing system 101 also executes the management of service classified by area 122, thereby providing a service classified by area to the user. The service classified by area means a service provided only to the users living in a specified area (ex., a residential area). For example, the service classified by area includes taxi reservation in a subject area, product buying in a shop opened for business in the subject area.

The management of common service 121 and the management of service classified by area 122 are synchronized with each other by a synchronization processing 124. The synchronization processing means matching between information of state when a service is provided to a user by the management of common service 121 and information of state when a service is provided to the user by the management of service classified by area 122. This processing will be described more in detail later.

The system in this embodiment further enables the user of a service access apparatus 301, which is a customer of the system, to use the services of a company cooperated with the service providing company that operates this service providing system 101 in addition to the services provided by the service providing system 101. The service providing system of cooperated company 201 is an apparatus that provides the services of the cooperated company. The service providing company that runs the service providing system of cooperated company 201 (hereinafter to be referred to as a cooperated service providing company) and the service providing company that runs the service providing system 101 are associated with each other under a contract. The users of the service providing system 101 can thus access the service providing system of cooperated company 201 via the service providing system 101. Specifically, the service access program 311 of the service access apparatus 301 can access the service providing system of cooperated company 201 via the substitute reply processing 123 of the service providing system 101 so as to use various services of the cooperated company provided via the management of service of cooperated company 221. At this time, the user is not required to register himself/herself in the service providing system of cooperated company 201 so as to obtain an ID; the user can receive a service of the cooperated company just like a service provided from the service providing system 101 without knowing the difference.

FIG. 4-1 shows a network block diagram of an alternate embodiment of the present invention. The central server 101-1 has many of the functions of the service providing system 101 of FIG. 4, including the management of common service 121, the substitute reply processing 123, and synchronization processing 124. However, the management of service classified by area 122 has been decentralized into local servers by area, for example, Area1 Server 122-1 and Area2 Server 122-2. Central server 101-1 is connected to Area1 Server 122-1 and Area2 Server 122-2 via main network 400-1. The area servers are franchise servers of the central server and provide local area Web page content and services. For example, Area1 Server 122-1 is connected to User1 301-1, user2 301-2 and Coop Co. 2 Server 201-2 via area network 400-2. Area2 Server 122-2 receives services from Coop co. 3 server 201-3 and provides those services to user3 301-3 via area2 network 400-3. The users, e.g., users 301-1, 301-2, and 301-3, still log on to the central server 101-1 with their user ID and password for access to all services they are entitled to, but in this embodiment the area server is the Web server for the user, i.e., both local content and content from the central server 101-1 is sent, for example, from area1 server 122-1 to user1's 301-1 Web browser via area1 network 400-2. The users (301-1, 301-2, and 301-3) are similar to the service access apparatus 301, and the Coop Co. Servers 201-1, 201-2, and 201-3 are similar to the service providing system of cooperated company 201 of FIG. 4. Coop Co. 1 Server 201-1 gives an example of a cooperated (Coop) company (Co.) service that is provided via the main network 400-1, for example a travel service, while Coop Co. 2 Server 201-2 gives an example of a local service, such as, from a local taxi company.

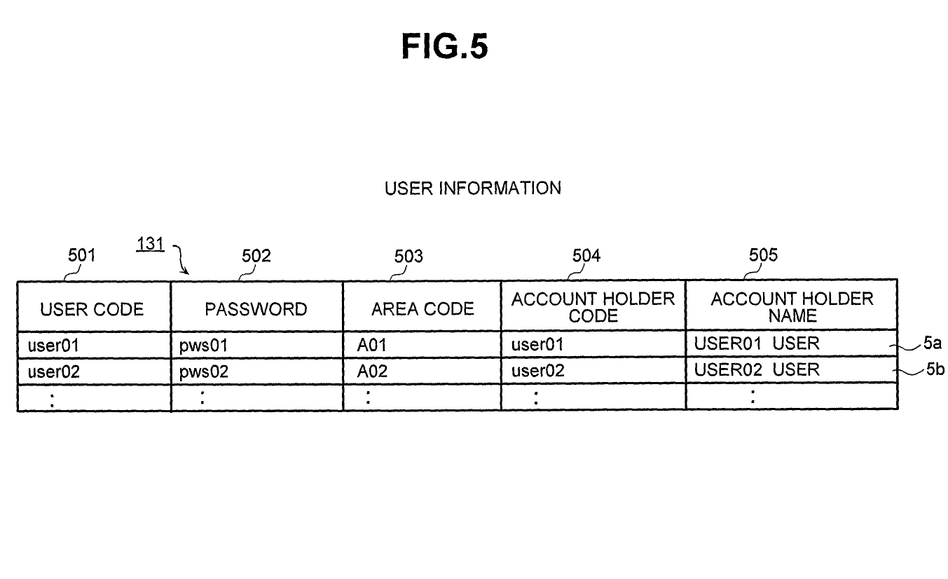

FIG. 5 is a configuration of user information 131 stored in the data memory 117 of the service providing system 101. The user information 131 is a table for storing various information items of a user who can receive services provided by the service providing system 101. The user information table 131 includes fields of user code 501, password 502, area code 503, account holder code 504, and account holder name 505.

The user code 501 is an ID used to identify a user. The password 502 is needed by the user to access the service providing system 101. The area code 503 is used to identify an area to which the user belongs. The account holder code 504 identifies an account holder who pays for a service provided from the service providing system 101 as needed. The account holder name 505 is the name of the account holder, for example. A user who wants to receive a service from the service providing system 101, before using the service actually, must make an application to the subject service providing company that runs the service providing system 101 and his/her personal information is registered in the user information table 131.

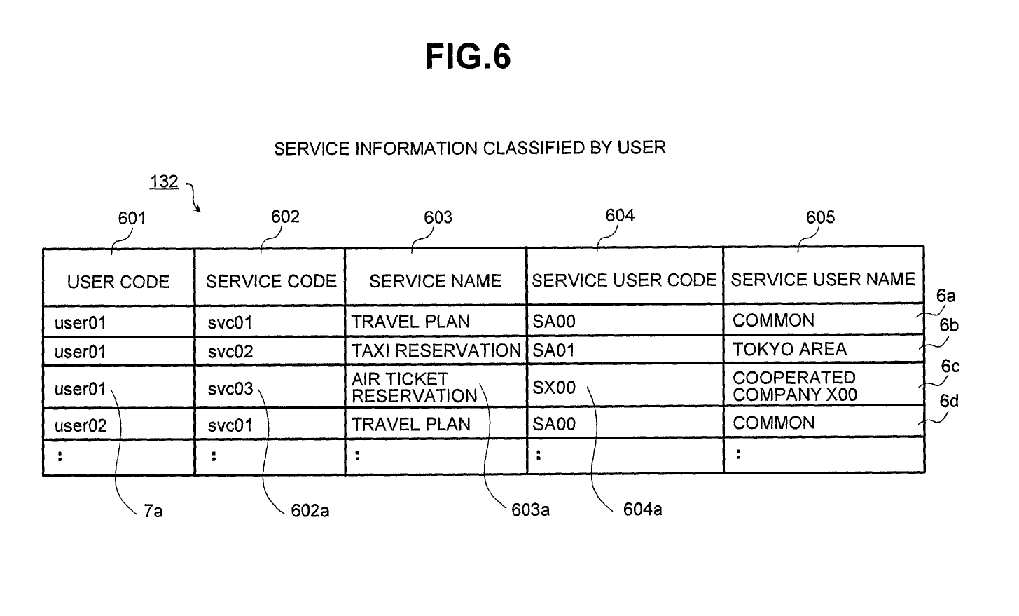

FIG. 6 is a configuration of the service information classified by user 132 stored in the data memory 117 of the service providing system 101. The service information classified by user 132 is a table for storing information denoting services accessible, i.e., allowed for use by the user. The service information classified by user 132 includes fields of user code 601, service code 602, service name 603, service user code 604, and service user name 605.

The user code 601 is used to identify a user. The service code 602 and the service name 603 are used to identify a service usable by the user. The service user code 604 and the service user name 605 are used to denote information on the service provided. For example, because SA00 denotes “Common” 6a for the service providing company name 605, the service is a common one provided to all the users. SA01 denotes that the subject service is a service classified by area, which is provided only to the users in the Tokyo area 6b. SX00 604a denotes that the subject service is provided by the cooperated company X00 6c. Those information items are set for a user when the user is registered in the user information 131 (or later).

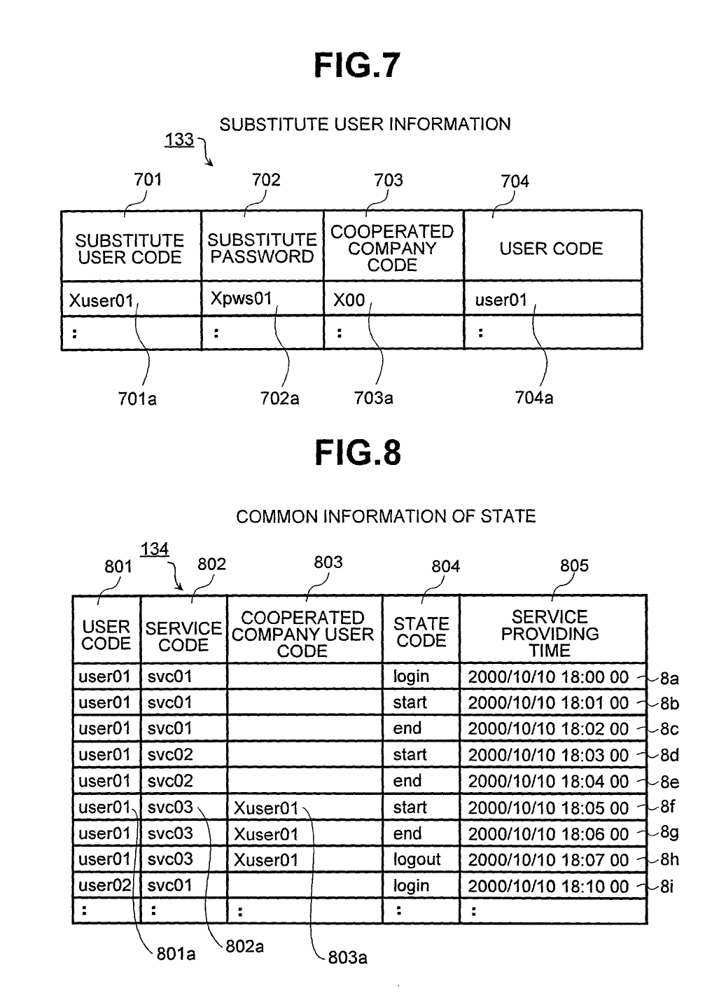

FIG. 7 is a configuration of the substitute user information 133 stored in the data memory 117 of the service providing system 101. The substitute user information 133 is a table for storing items of ID and password allocated to a user and used to access the service providing system of cooperated company 201 associated with the service providing system 101 via the service providing system 101. The substitute user information 133 includes fields of substitute user code 701, substitute password 702, cooperated company code 703, and user code 704.

The substitute user code 701 is a user code (ID) allocated automatically to a user when the user accesses the service providing system of cooperated company 201 through a substitute replay processing 123 executed by the service providing system 101. The substitute password 702 is a password corresponding to the substitute user code 701. The cooperated company code 703 is used to identify the service providing system of cooperated company 201 to be accessed with use of the substitute user code 701 and the substitute password 702. The user code 704 identifies a user who is accessing the service providing system of cooperated company 201. For example, user01 704a may want to access Cooperated Company X00 703a (6c in FIG. 6), i.e., Air Ticket Reservation 603a service with Service Code SX00 604a. Service providing System 101 logs on to the service providing system of cooperated company X00 703a using substitute user code Xuser01 701a and the substitute password Xpws01 702a.

In this embodiment, the number of users who can access the service providing system of cooperated company 201 concurrently via the service providing system 101 is decided beforehand under the contract made between the service providing company and the cooperated company 201. The user codes (ids) and passwords for those decided number of users used to access the service providing system of cooperated company 201 are given to the service providing company 101 by the cooperated company 201. The user ids are essentially a set of unassigned or anonymous user ids which may be used to login to the service providing system of cooperated company 201 by the service providing system 101. The service providing system 101 will do the mapping of these unassigned or anonymous user ids (codes), and also the unassigned user associated passwords, in the table 133 in FIG. 7. The service providing company 101 thus sets received information in the substitute user code 701 and the substitute password 702 of the substitute user information table 133. The user code 704 is kept emptied until the user requests an access to the service providing system of cooperated company 201 so that the user can access the cooperated company with use of the corresponding substitute user code 701 and password 702 so as to use a service thereof.

FIG. 8 is a configuration of the common information of state 134 stored in the data memory 117 of the service providing system 101. The common information of state 134 is a table for storing information related to the services (including not only common services, but also services classified by area and by cooperated company) used by all the users. The common information of state 134 includes fields of user code 801, service code 802, cooperated company user code 803, state code 804, and service providing time 805.

The user code 801 is used to identify a user who uses a service. The service code 802 is used to identify a service used by the user. The user code of cooperated company 803 is used to store a substitute user code (701 in FIG. 7) used to access the service providing system of cooperated company 201 when the user uses a service of a cooperated company provided via the service providing system of cooperated company 201. For example user01 801a (user01 7a in FIG. 6) has service code svc03 802a (svc03 602a in FIG. 6) and cooperated company user code Xuser01 803a (substitute user code Xuser01 701a of FIG. 7). The state code 804 stores the various states that occur when the user uses a service. For example, the state code 804 stores such states as login and logout, or start and end. The service providing time 805 stores a time at which the subject state occurs.

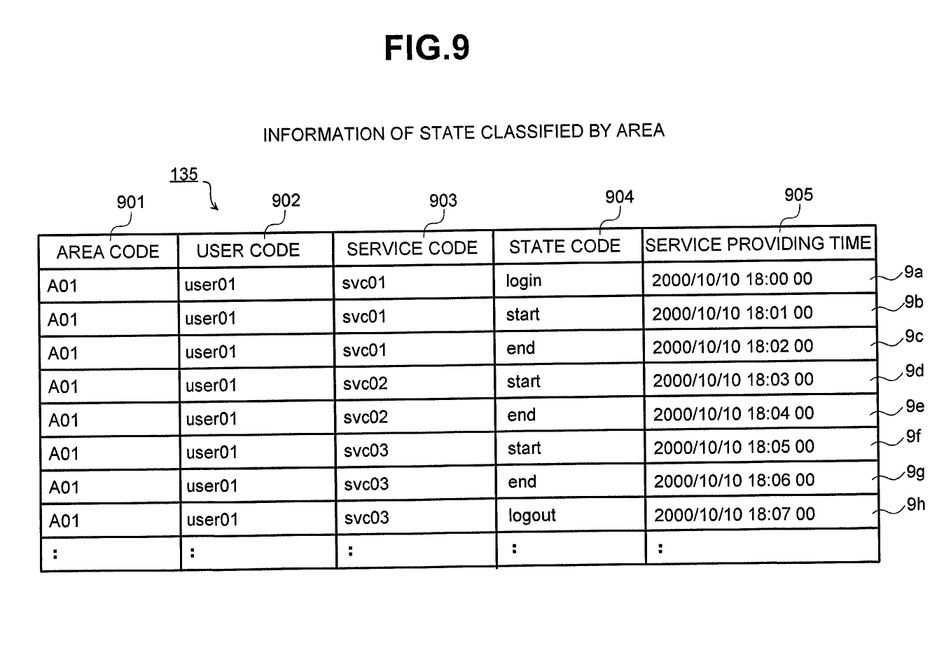

FIG. 9 is a configuration of the information of the state classified by area 135 stored in the data memory 117 of the service providing system 101 of an embodiment of the present invention. The information of the state classified by 135 is set for each area. In the information of state classified by area 135 is stored with respect to services (including not only services classified by area, but also common services and services of cooperated companies) used by the users who live in the subject area. The information of state classified by area 135 includes fields of area code 901, user code 902, service code 903, state code 904, and service providing time 905.

The user code 902 identifies a user. The area code 901 identifies an area to which the user belongs. The service code 903 stores a code for identifying a service used by the user. The state code 904 stores various states to occur when a service is used. The service providing time 905 stores a time at which the state occurs.

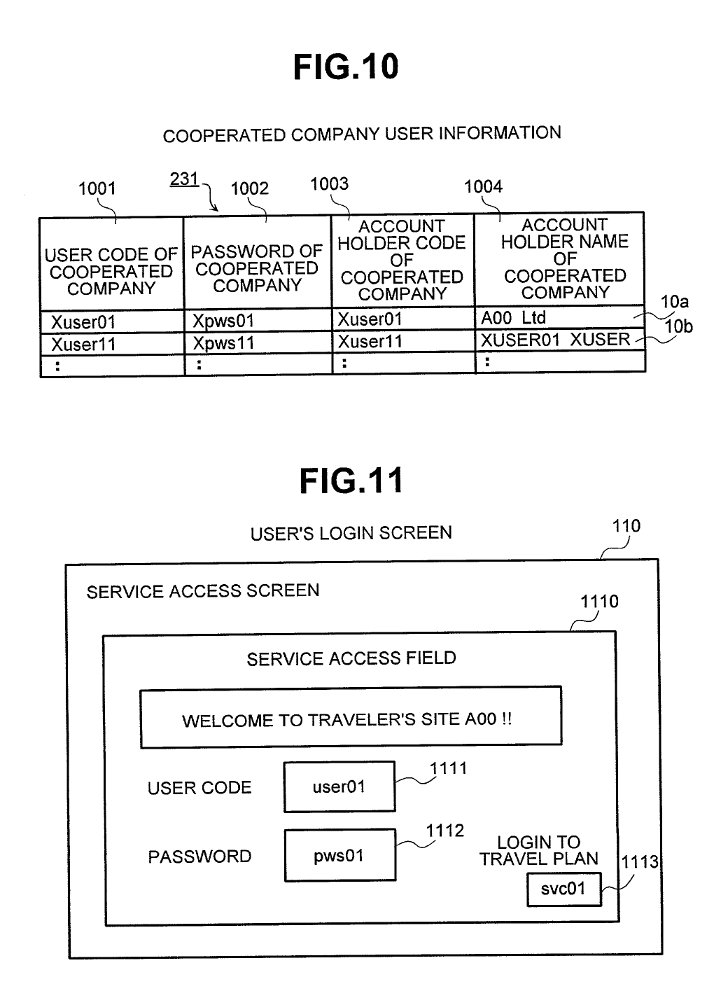

FIG. 10 is a configuration of the user information of cooperated company 231 stored in the data memory 217 of the service providing system 101. The user information of cooperated company 231 is a table for storing preset items of user code and password with which the service providing system of cooperated company 201 accepts an access. The user information of cooperated company 231 includes fields of user code of cooperated company 1001, password of cooperated company 1002, account holder code of cooperated company 1003, and account holder name of cooperated company 1004.

The user code of cooperated company 1001 (corresponding to 701 in FIG. 7) that was sent by cooperated company 201 in order to access the cooperated company 201 system is stored by service providing system 101. The password of cooperated company 1002 corresponding to the user code is also stored in memory 217. The account holder code of cooperated company 1003 and the account holder name of cooperated company 1004 store a code and a name used to identify the account holder corresponding to the user code of cooperated company 1001 and the password of cooperated company 1002. The account holder is, for example, a person who pays for a service of the service providing system of cooperated company 201. However, because the accounting generated when the user uses a service of the service providing system of cooperated company 201 via the service providing system 101 is charged to the original requester of the user IDs and passwords, the account holder is not an individual user 301, but the service providing system 101. The service providing system 101 then passes on the service fee from the cooperated company 201 to the individual user 301. The service providing system 101 may optionally charge the user 301 a small fee for this pass-through service.

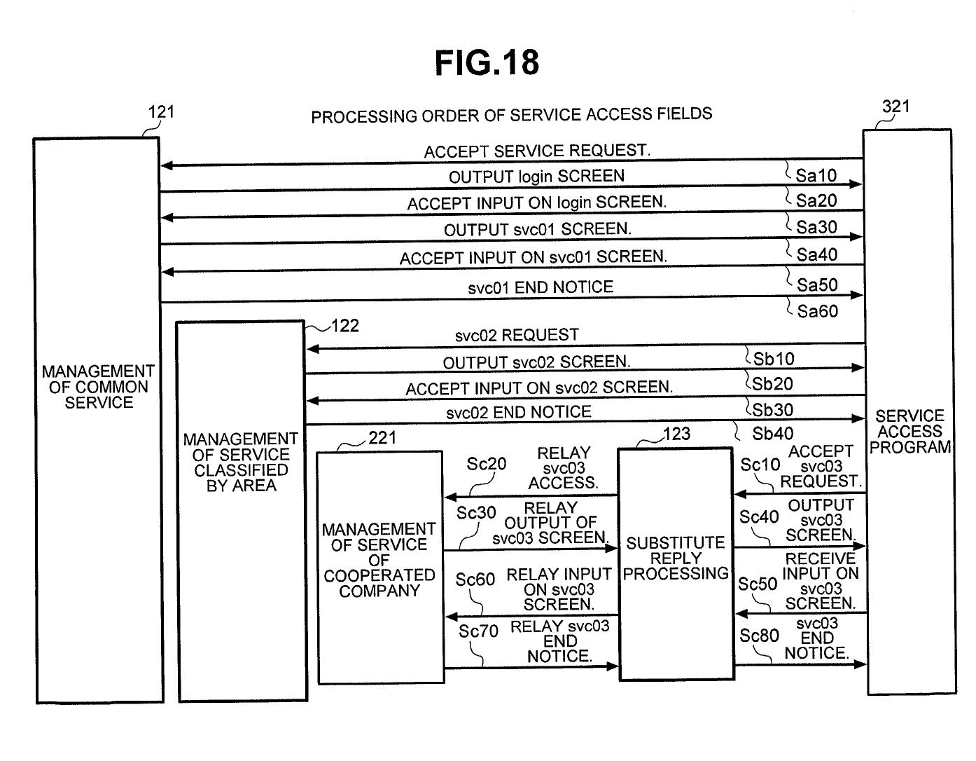

FIGS. 11 through 17 show examples of the service access screen displayed at the system in this embodiment. FIG. 18 shows an example of the processing order of management of service providing in the system in this embodiment. Hereinafter, a description will be made for each screen displayed on the display block 317 of the service access apparatus 301 when processings are executed sequentially in the order shown in FIG. 18.

In FIG. 18, the service access program 321, for example an Internet browser, that runs in the service access apparatus 301, for example a personal computer or cell phone or Personal Digital Assistant (PDA), operated by the user, when the user requests a common service, issues the service request to the management of common service 121(Sa10). In response to this request, the management of common service 121 displays the screen 1110 shown in FIG. 11 on the service access screen 1101 of the service access apparatus 301 (Sa20 in FIG. 18). This screen 1110 is a travelers' site A00 login screen. The screen 1110 has a user code input field 1111, a password input field 1112, and a button 1113 for logging in the travel plan screen (service code: svc01). On this screen 1110, the user is requested to enter his/her user code and password (those registered in the user information 131 in FIG. 5) in the user code input field 1111 and the password input field 1112, then press the log-in button 1113.

The service access program 321 then sends the user code and the password entered by the user to the management of common service 121(Sa30 in FIG. 18). Checking the user code and the password, the management of common service 121 displays the screen svc01 for starting the common service (Sa40 in FIG. 18).

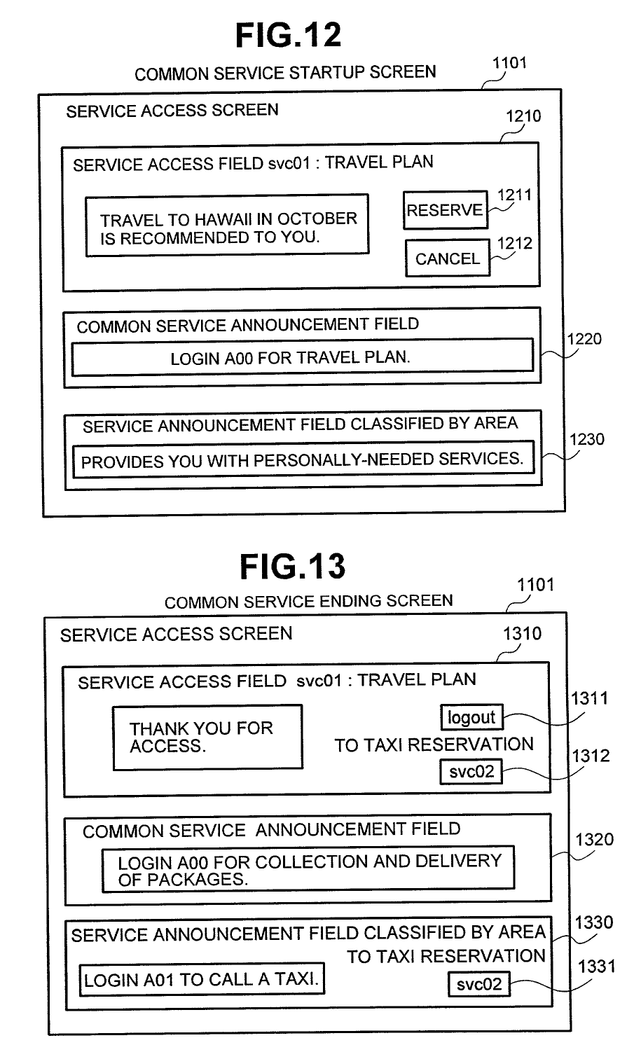

FIG. 12 shows an example of the screen svc01 for starting the common service to be displayed on the display block 317 of the service access apparatus 301. On the service access screen 1101 is displayed a field 1210 received from the management of common service 121; field 1210 is used for logging in travel plan. In addition to an advertisement message of travel plan recommended to the user, the field 1210 also displays a RESERVE button 1211 used to reserve a travel plan and a CANCEL button 1212.

The service access screen 1101 always displays the original service access field, as well as a common service announcement field and a service announcement field classified by area. In one embodiment the screen 110 (FIG. 11) and screen 1101 (FIG. 12) is has information sent directly from the central server 101-1 to the user, for example, user 301-1. In an alternate embodiment the screen information from the central server 101-1 is sent indirectly through, for example, the area1 server 122-1 to the user1 301-1.

In FIG. 12, numeral 1220 denotes the common service announcement field and 1230 denotes the service announcement field classified by area. The common service announcement field 1220 displays various announcement messages on common services including the information about a common service expected as the next service to be accessed by the user, according to the state of the service execution up to that time. The service announcement field classified by area 1230 displays various announcement messages on services classified by area, including the information about a service classified by area expected as the next service to be accessed by the user. The common service announcement field 1220 and the service announcement classified by area 1230 may display, for example, a newly set frame and a newly opened window with use of the service access program (browser) that runs in the service access apparatus 301. In an alternative embodiment the information for the service announcement classified by area 1230 comes directly from the area server, for example, area1 server 122-1.

Assume that after that, the user has pressed the RESERVE button 1211 on the screen shown in FIG. 12 so as to reserve the recommended travel plan. The system thus accepts the input done on the screen svc01 (the reservation for travel to Hawaii in this case)(Sa50 in FIG. 18). Ending this reservation processing, the management of common service 121 sends an end notice of the service svc01 (this travel plan) to the service access program 321 (Sa60).

FIG. 13 shows an example of a screen for ending a common service. The screen is sent in Sa60. On the service access screen 1101 is displayed the ending service access field 1310 for the travel plan. This field 1310 displays a message “Thank you for accessing” when the service is ended, as well as a LOGOUT button 1311 and a RESERVE button 1312 (service code: svc02) used for taxi reservation, which is considered to be necessary for the travel plan accepted at that time. The common service announcement field 1320 displays a common service advertisement message for the service recommended to the user and the service announcement field 1330 displays an advertisement message of a service classified by area, recommended to the user. In particular, the service classified by area 1330 displays a button (service code: svc02) 1331 for calling the reservation screen for taxi reservation expected to be needed in the travel just after a travel plan reservation service is executed.

Assume that the user has pressed this RESERVE button 1312 (or 1331) for taxi reservation, which is one of the services classified by area recommended on the screen shown in FIG. 13. Consequently, the service access program 321 sends a service request for service code svc02 (a service available only in that area) to the management of service classified by area 122(Sb10 in FIG. 18), for example Coop Co.2 Server 201-2 in FIG. 4-1. In response to the request, the management of service classified by area 122 displays the screen svc02 for taxi reservation (Sb20).

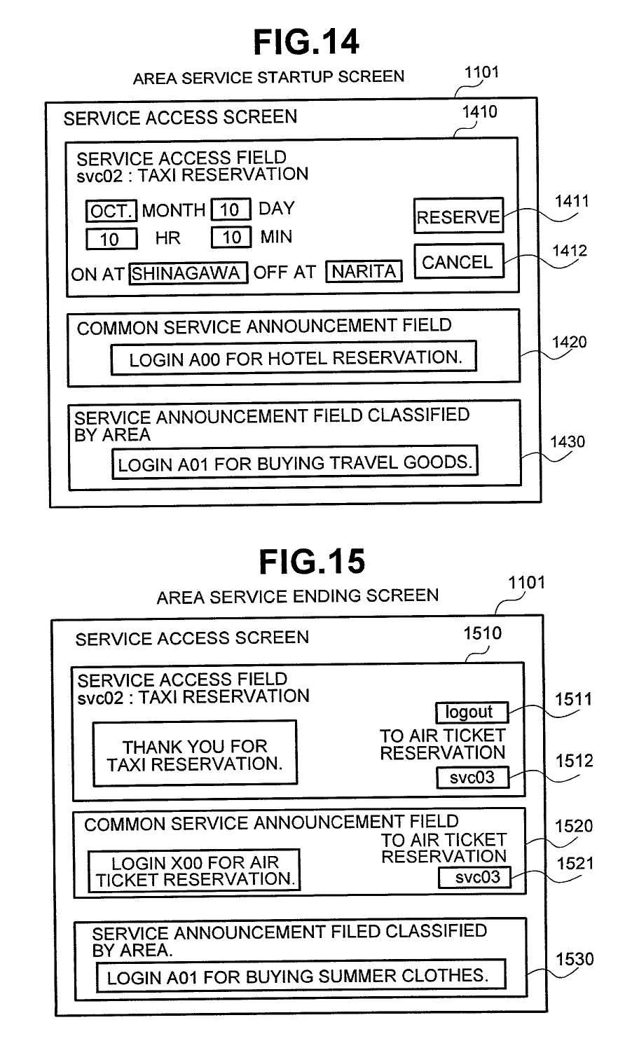

FIG. 14 shows an example of a field 1410 displayed on the display block 317 of the service access apparatus 301. The service access program 321 receives the field 1410 from the management of service classified by area 122 in Sb20. The field 1410 for taxi reservation (service code: svc02) is displayed on the service access screen 1101. This field 1410 displays the date and time on which a taxi reservation is made, as well as places to get on and off according to the travel plan reservation made by the user. The date and time, as well as the places to get on and off are set automatically on the field 1410. The field 1410 also displays a RESERVE button 1411 and a CANCEL button 1412. The common service announcement field 1420 displays an advertisement message about a common service expected as the next service to be accessed by the user. In the same way, the service announcement field 1430 classified by area displays an advertisement message about a service specific to the area and expected as the next service to be accessed by the user.

To reserve a taxi on the screen 1410 shown in FIG. 14, the user presses the RESERVE button 1411. Assume that the user has pressed the RESERVE button 1411. Then, the service access program 321 sends the command that the RESERVE button 1411 has been pressed, to the management of service classified by area 122(Sb20 in FIG. 18). In response to the command, the management of service classified by area 122 then processes the taxi reservation. When the processing is ended, the management of service classified by area 122 sends the service ending screen to the service access program 321(Sb40).

FIG. 15 shows an example of a field 1510 displayed on the display block 317 of the service access screen 301. The service access program 321 receives the screen 1510 from the management of service classified by area 122 in Sb40. The field 1510 appears on the service access screen 1101 when the taxi reservation is ended. The field 1510 displays a LOGOUT button 1511, and a svc03 button 1512 for calling an air ticket reservation service (service code: svc03), which is expected as the next service to be accessed by the user. The common service announcement field 1520 and the service announcement field classified by area 1530 display advertisement messages about services expected as the next items to be accessed by the user respectively. The air ticket reservation service svc03 recommended to the user is a service of a cooperated company. The service is displayed in the common service announcement field 1520 at this time, since there is no need to let the user know how the service is provided to the user.

Assume that the user has pressed the reserve button 1512 so as to reserve an air ticket on the field 1510 shown in FIG. 15. Then, the service access program 321 sends the command that the button 1512 has been pressed so as to access the air ticket reservation, to the substitute reply processing 123(Sc10 in FIG. 18). In response to the command, the substitute reply processing 123 relays the access to the management of service of cooperated company 221(Sc20). In response to the request, the management of service of cooperated company 221 sends the air ticket reservation screen (service code: svc03) to the substitute reply processing 123(Sc30). The substitute reply processing 123 relays the screen and sends it to the service access program 321(Sc40), so that the air ticket reservation screen is displayed on the display block 317 of the service access apparatus 301.

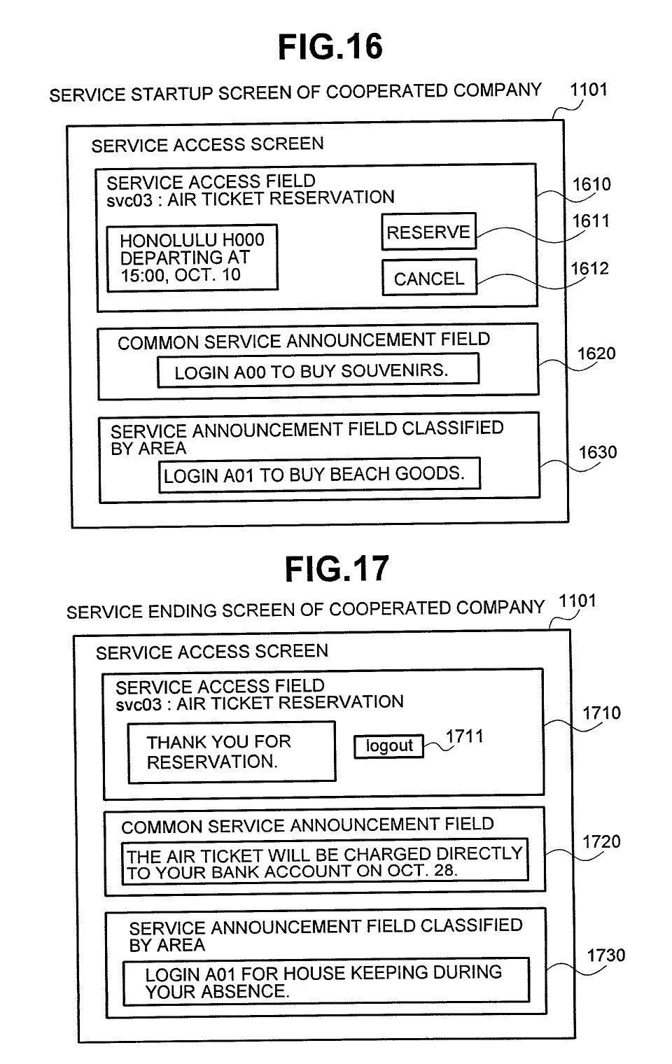

FIG. 16 shows an example of a service access screen 1101 for the air ticket reservation service, which is one of the services of a cooperated company received such way. The service access screen 1101 displays an air ticket reservation access filed 1610 in which a reserve button 1611 and a cancel button 1612 are displayed. The destination, as well as the date and time for the departure of the flight to be reserved are selected optimally according to the travel plan reserved previously by the user and displayed there. The user is then requested to press the reserve button 1611 to reserve the flight and press the cancel button 1612 to stop the flight reservation service. The common service announcement field 1620 and the service announcement field classified by area 1630 display advertisement messages about the services expected as the next services to be accessed by the user respectively.

Assume that the user has pressed the reserve button 1611 to reserve the recommended flight. Then, the service access program 321 sends the command that the button 1611 has been pressed, to the management of service of cooperated company 221(Sc50 and Sc60 in FIG. 18). In response to the command, the management of service of cooperated company 221 processes the flight reservation. When the reservation is ended, the management of service of cooperated company 221 sends the ending screen for the service of a cooperated company to the service access program 321 via the substitute reply processing 123 (Sc70 and Sc80).

FIG. 17 shows an example of the service access screen 1101 to appear when this service of the cooperated company is ended. On the service access screen 1101 are displayed the flight reservation ending field 1710 in which a logout button 1711 is displayed. The common service announcement field 1720 and the service announcement field classified by area 1730 display information related to the reservation made by the user, as well as advertisement messages about services expected as the next services to be accessed by the user respectively.

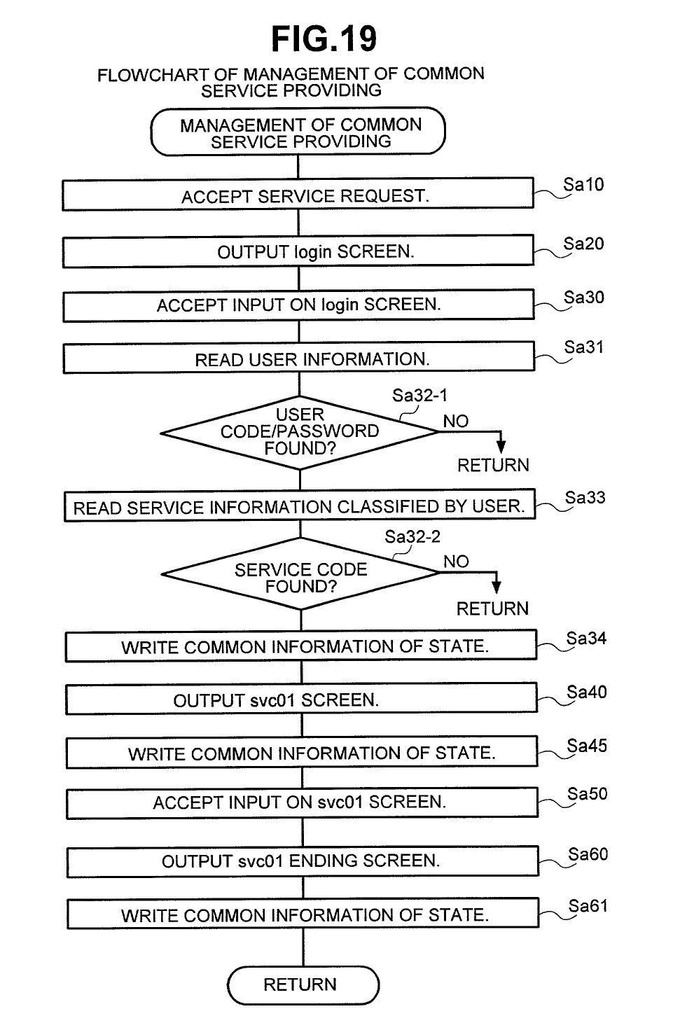

A description will be made for the processing procedures executed in the system in this embodiment (in particular, those described with reference to FIGS. 11 through 18) with reference to the flowcharts shown in FIGS. 19 through 25. Assume that the same symbols (Sa10, Sa20, etc.) are given to the same steps in FIGS. 19 through 25 as those shown in FIG. 18.

FIG. 19 is a flowchart of the management of common service 121 executed by the service providing system 101. At first, the management of common service 121 executes a processing for accepting a service request issued by the user with use of the service access program 321 of the service access apparatus 301 in step Sa10. In response to the request, the system displays the login screen shown in FIG. 11 in step Sa20. The system then accepts such information as the user code and the password entered by the user on the login screen in step Sa30. Then, the system reads the user information 131 described with reference to FIG. 5 in step Sa31 so as to check whether or not the user code and the password entered by the user in step Sa32-1 are identical to those registered in the user information 131. Where they are illegal, the system stops the processing and control returns to the previous step.

When the user code and the password are correct, the system reads the service information classified by user 132 described in reference to FIG. 6 in step Sa33. After that, the system checks whether or not the service code specified by the user at the login time is registered in the service information classified by user 132 in step Sa32-2 (that is, whether or not the user is enabled to use the service). When the service code is not registered, the user is not enabled to use the service. The system thus stops the processing and returns to the previous step. Where the service code is registered in the information 132, control goes to step Sa34.

In step Sa34, the system writes the effect that the user has logged in the processing, in the common information of state 134. In the example, the effect is written just like the row data 8a shown in FIG. 8. After that, the system displays the service code svc01 screen shown in FIG. 12 in step Sa40. In step Sa45, the system writes the effect that the svc01 service has been started in the common information of state 134 just like the row data 8b in FIG. 8. Then, the system accepts the information entered by the user on the screen shown in FIG. 12 in step Sa50. It is assumed here that the user has pressed the reserve button 1211 so as to process the reservation. When the reservation is ended, the system displays the svc01 service ending screen in step Sa60. In this case, the service ending screen shown in FIG. 13 is displayed. After that, the system writes the svc01 service ending information in the common information of state 134 just like the row data 8c in FIG. 8.

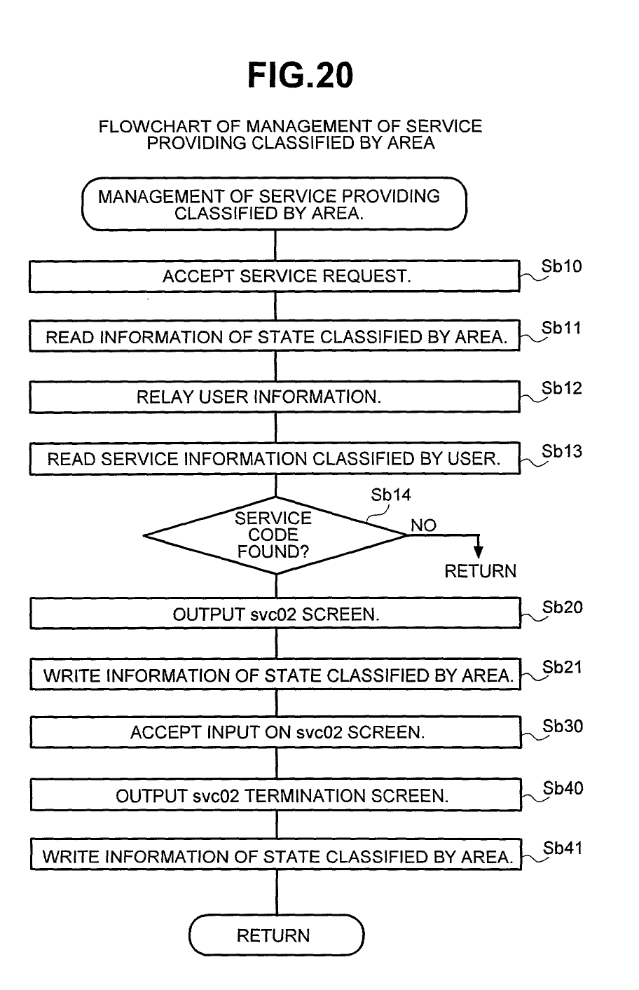

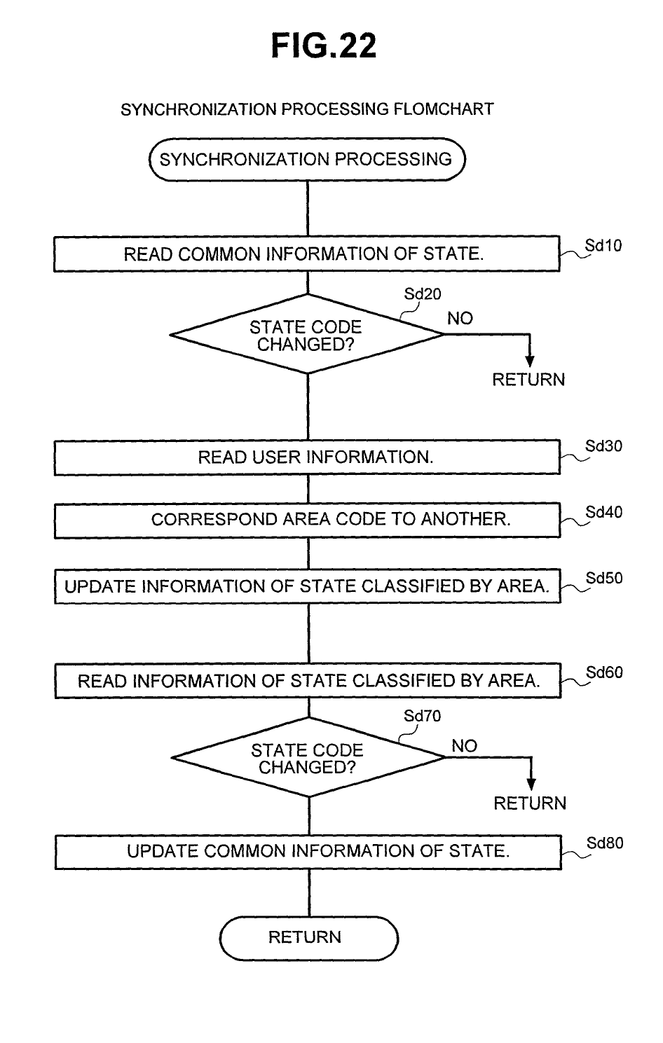

FIG. 20 is a flowchart of the management of service classified by area 122 executed by the service providing system 101. At first, the system accepts a request for a service classified by area from a user in step Sb10. The system then reads the information of state classified by area 135 shown in FIG. 9 in step Sb11 and takes over the user information in step Sb12. Taking over user information means a processing for obtaining user information read in the previous step Sa31. Then, the system reads the service information classified by user 132 shown in FIG. 6 in step Sb13 and checks whether or not the service code specified by the user is registered in the service information classified by user 132 in step Sb14. Where the service code is not registered, the user is not enabled to use the service. The system thus stops the processing and returns to the previous step.

Where it is decided in step Sb14 that the service code is registered, the system displays the screen for the specified service classified by area in step Sb20. In this example, the taxi reservation screen svc02 shown in FIG. 14 is displayed. After that, the system writes the result that the service has been started in the information of state classified by area 135 shown in FIG. 9 in step Sb21. In this example, the row data 9d in FIG. 9 is written. The information written in the common information of state 134 shown in FIG. 8 is reflected in the information of state classified by area 135 shown in FIG. 9 by a synchronization processing 124 to be described later with reference to FIG. 22. The information written in the information of state classified by area 135 shown in FIG. 9 is reflected in the common information of state 134 shown in FIG. 8. This means that the information items 9a to 9c related to the previously executed common service are already written there when row data 9d is written.

The system then accepts an input on the screen for the service classified by area in step Sb30. It is assumed here that the user has pressed the reserve button 1411 shown in FIG. 14 so as to reserve a taxi. When the taxi reservation is ended, the system displays the ending screen of the management of service classified by area 122 in step Sb40. In this example, the ending screen shown in FIG. 15 is displayed. Then, the system writes the row data 9e denoting the effect that the svc02 service has been ended, in the information of state classified by area 135 shown in FIG. 9 in step Sb41 and returns to the previous step.

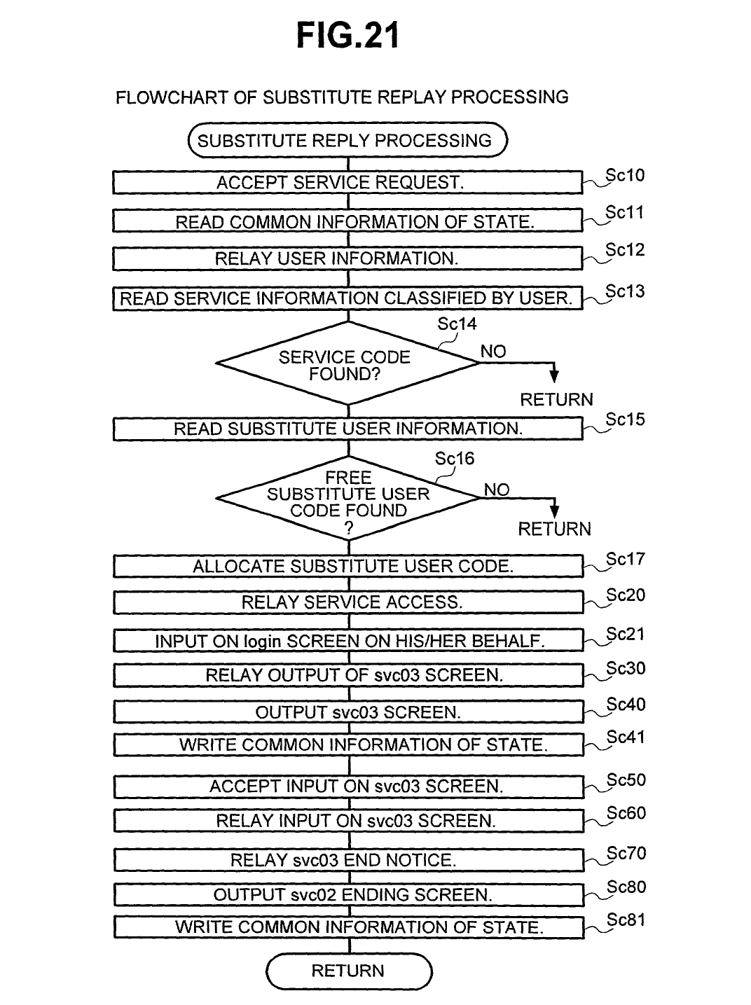

FIG. 21 is a flowchart of the substitute reply processing 123 executed by the service providing system 101. Accepting the service request (for a service of a cooperated company) from the user in step Sc10, the system reads the common information of state 134 shown in FIG. 8 in step Sc11, then takes over the user information in step Sc12. After that, the system reads the user's service information classified by user in step Sc13 and checks whether or not the service of the cooperated company specified by the user is registered in the service information classified by user 132 in step Sc14. When the service code is not registered, the user is not enabled to use the service. The system thus stops the processing and returns to the previous step.

Where it is decided in step Sc14 that the service code is registered, the system reads the substitute user information 133 shown in FIG. 7 in step Sc15. The system then searches an empty user code field 704 in the substitute user information 133 in step Sc16. Where no such an empty substitute user code is found, the system stops the processing and returns to the previous step. Where an empty substitute user code is found, the system allocates the substitute user code in step Sc17. Specifically, the system writes the subject user code in the user code field 704 in the substitute user code row of the substitute user information 133 just like the row data 704a in FIG. 7.

Then, the system takes over the service access in step Sc20. This is a processing for obtaining the login screen from the service providing system of cooperated company 201. In step Sc21, the system inputs data on the login screen for the service providing system of cooperated company 201. This is a processing for logging in the service providing system of cooperated company 201 automatically with use of the substitute user code and the substitute password corresponding to the service code allocated respectively in step Sc17. In response to this login, the specified service providing screen is sent to the system from the service providing system of cooperated company 201. The system thus relays the screen data (1610 in FIG. 16) to the service access apparatus 301 in step Sc40. After that, the system writes the effect that the service providing system of cooperated company 201 has started the specified service, in the common information of state 134 shown in FIG. 8 in step Sc41.

The system then accepts an input from the service providing system of cooperated company 201 on the service screen in step Sc50. This is a processing for accepting an input on the screen for services of a cooperated company shown in FIG. 16. Accepted data is relayed in step Sc60 to the service providing system of cooperated company 201. When the cooperated company's service is ended, the system relays the end notice to the service providing system of cooperated company 201 in step Sc70 and displays the ending screen in step Sc80. In this case, the screen 1710 for ending the cooperated company's service shown in FIG. 17 is relayed to and displayed on the screen of the service access apparatus 301. After that, the system writes the effect that the service has been ended, in the common information of state 134 shown in FIG. 8 just like the row data 8g and 8h, then returns to the previous step.

FIG. 22 is a flowchart of the synchronization processing 124 executed by the service providing system 101. This processing 124 is always repeated at predetermined intervals. At first, the system reads the common information of state 134 shown in FIG. 8 in step Sd10, then checks whether or not the state code 804 is changed in step Sd20. Where the state code is not changed, control returns to the previous step. Where the state code is changed (that is, new row data is added to the common information of state 134), the system reads the user information 131 in step Sd30, then obtains an area code 503 corresponding to the user code 801 of the row data added newly to the common information of state 134 in step Sd40. Then, the system adds the row data added newly to the common information of state 134 as described above to the information of state classified by area 135 together with the area code obtained in the previous step in the next step Sd50. Consequently, the data added to the common information of state 134 is affected in the information of state classified by area 135.

The processing's in steps Sd60 to Sd80 are executed so as to reflect the data added to the information of state classified by area 135 in the common information of state 134. Specifically, the system reads the information of state classified by area 135 in step Sd60, then checks whether or not the state code is changed (whether or not any new row data is added to the information of state classified by area 135) in step Sd70. Where the state code 904 is not changed, the system returns to the previous step with no operation. Where the state code 904 is changed, the system makes the row data added to the information of state classified by area 135 reflect in the common information of state 134 in step Sd80, then returns to the previous step.

Because both of the common information of state 134 and the information of state classified by area 135 are stored in the service providing system 101 in this embodiment, the processings in steps Sd10 to Sd50 for reflecting the common information of state 134 in the information of state classified by area 135 are combined with the processings in steps Sd60 to Sd80 for reflecting the information of state classified by area 135 in the common information of state 134 into a series of processing's as shown in FIG. 22. Where the common information of state 134 and the information of state classified by area 135 are stored in different apparatuses, however, those processings must be executed separately in those different apparatuses.

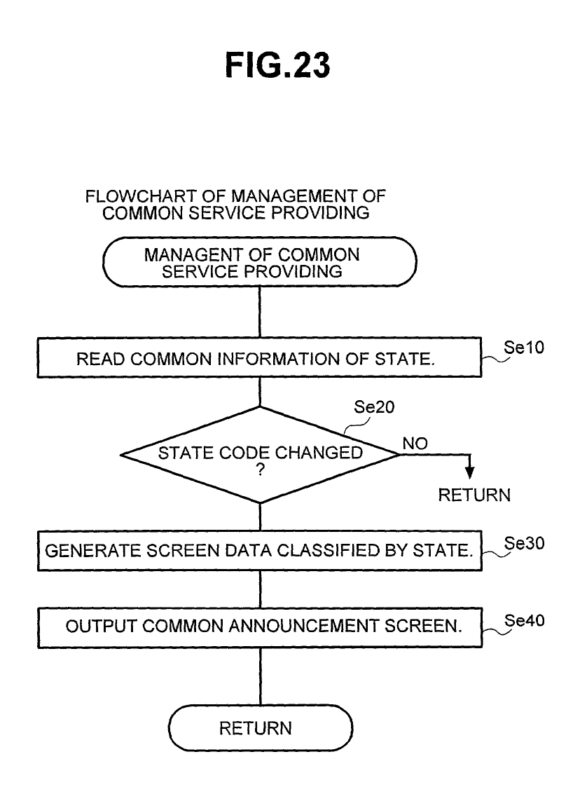

FIG. 23 is a flowchart of the management of common service announcement 125 executed by the service providing system 101. The common service announcement processing 125 is always repeated at predetermined intervals. At first, the system reads the common information of state 134 in step Se10, then checks whether or not the state code 804 is changed in step Se20. Where the state code 804 is not changed, the system returns to the previous step with no operation. Where the state code 804 is changed, the system generates screen data classified by state in step Se30, then displays the common service announcement screen in step Se40 and returns to the previous step. The screen data classified by state means screen data that should be announced to the user according to the state in the past or at that time. For example, because the common information of state 134 indicates that the user has used the reservation service for travel to Hawaii, the system displays a common service announcement screen for recommending an air ticket reservation service corresponding to the previous service.

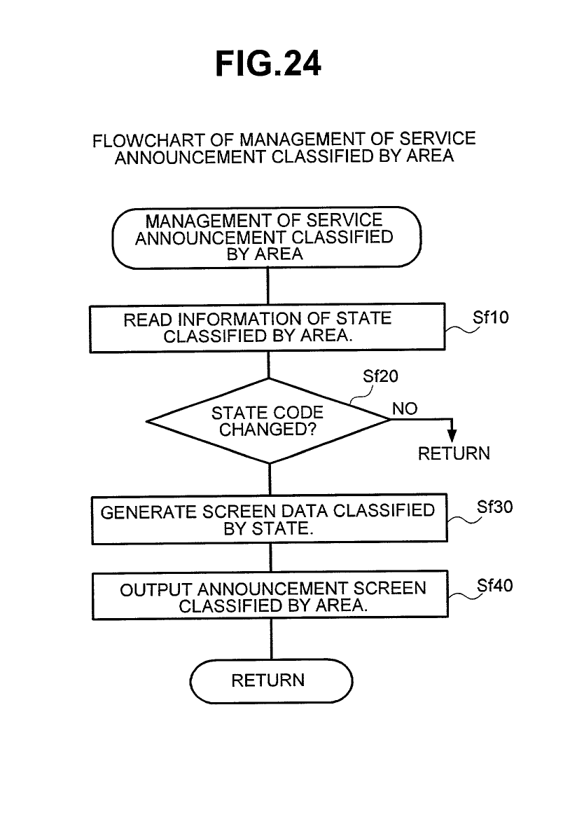

FIG. 24 is a flowchart of the management of service announcement classified by area 126 executed by the service providing system 101. The management of service announcement classified by area 126 is always repeated at predetermined intervals. At first, the system reads the information of state classified by area 135 in step Sf10, then checks whether or not the state code is changed in step Sf20. When the state code is not changed, control returns to the previous step. When the state code is changed, the system generates state screen data in step Sf30 and displays the service announcement screen classified by area in step Sf40. The system then returns to the previous step. The screen data classified by state means screen data that should be announced to the user according to the state in the past or at that time. For example, on the service access field shown in FIG. 16 is displayed a service announcement field classified by area, which recommends the user to buy some beach goods, since the information of state classified by area 135 indicates that the user has reserved a travel to Hawaii.

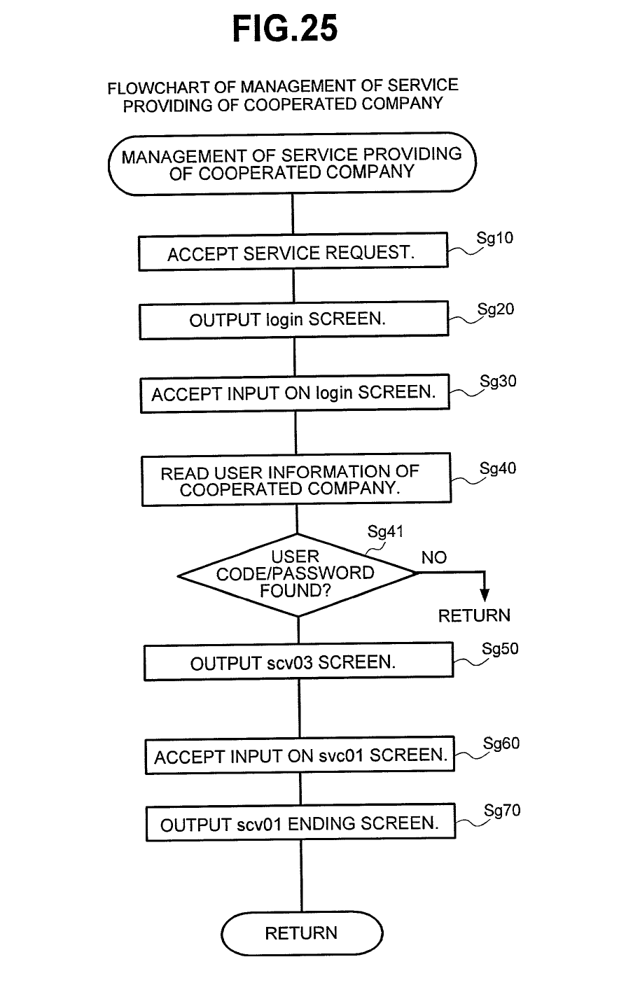

FIG. 25 is a flowchart of the management of service of cooperated company 221 executed by the service providing system of cooperated company 201. At first, the system accepts a service request from a user in step Sg10. Then, the system displays the login screen in step Sg20 and accepts an input done on the login screen in step Sg30. After that, the system reads the user information of cooperated company 231 in step Sg40 and checks the user code and the password of the user in step Sg41. Where the user code and the password are illegal, the system stops the processing and returns to the previous step. Where the user code and the password are correct, the system displays a service screen (ex., svc03 in FIG. 16) in step Sg50. The system then accepts an input done on the screen in step Sg60. When the processing ends, the system displays the ending screen in step Sg70 and returns to the previous step.

At this time, the service providing system of cooperated company 201 is not requested to distinguish the user's access between indirect one via the service providing system 101 and direct one from the user's own service access apparatus 301. This is because the input on the login screen is done in the substitute replay processing on behalf of the user as described with reference to FIG. 21 even when the user's access is done indirectly via the service providing system 101.

In one embodiment, the description has been made for a system configured by a service providing system 101, a service providing system of cooperated company 201, and a service access apparatus 301 connected to the communication network 400 respectively. However, each of those systems and apparatuses may be plural in number. For example, each user may have a plurality of service access apparatuses 101 connected to the network 400 and each cooperated company may have a plurality of service providing system of cooperated company 201 connected to the network 400 in case where there are a plurality of cooperated companies. The service providing system 101 may be realized by distributed processing's executed by a plurality of systems connected to the communication network 400. In this case, the processing's 121 to 126 shown in FIG. 1 may be executed by different systems. The information 131 may also be stored in different systems. In particular, in case where a system for providing common services is separated from a system for providing services classified by area, the information of state classified by area 135 and the service information classified by user 132 should be stored in different systems classified by area.

Because the access state of every user is recorded in the common information of state 134, the accounting of each user may be done according to the common information of state 134. Because the access state of each user in each area can be known by the information of state classified by area, it is possible for those apparatuses to build a relationship between a headquarter and franchise shops. For example, it is possible to install a server used for services classified by area in each area so as to calculate the access state of each user in the area and return profits to the manager of the server accessed by many users from the headquarter.

As described above, according to an embodiment of the present invention, a user is requested to register his/her access to just one service access apparatus so as to receive a service at another service access apparatus via the service access apparatus. The user can thus be freed from troublesome procedures, since he/she is not requested to register his/her access to each service access apparatuses. The user can also omit management of his/her user ID and password for each service apparatus, thereby his/her labor is much reduced. Because the user's personal information is stored only in the service access apparatus he/she has registered his/her access, he/she is much freed from worry about the illegal use of his/her personal information by others. As a result, embodiments of the present invention can realize simple and high security services. Each company that runs a service providing system can also provide a variety of attractive services to get an advantage over other companies so as to obtain many more users in the market.

Another embodiment of the present invention provides a computer readable medium for storing code for providing use by a user of a plurality of services through a common access point. The code for providing said user access to a first computer system; code for said first computer system accessing a second computer system comprising said service in response to a user request for a service of said plurality of services; and code for providing said service to said user from said second computer system through said first computer system.

Although the above functionality has generally been described in terms of specific hardware and software, it would be recognized that the invention has a much broader range of applicability. For example, the software functionality can be further combined or even separated. Similarly, the hardware functionality can be further combined, or even separated. The software functionality can be implemented in terms of hardware or a combination of hardware and software. Similarly, the hardware functionality can be implemented in software or a combination of hardware and software. Any number of different combinations can occur depending upon the application.

Many modifications and variations of the present invention are possible in light of the above teachings. Therefore, it is to be understood that within the scope of the appended claims, the invention may be practiced otherwise than as specifically described.

What is claimed is:

1. A method for a user to use a plurality of services through a common access point, comprising:
providing said user access to a first computer system;
responsive to a user request for a service of said plurality of services, said first computer system accessing a second computer system, comprising said service; and
providing said service to said user from said second computer system through said first computer system.

2. The method of claim 1 wherein said second computer system is not provided with any information on said user, when said first computer system accesses said second computer system.

3. The method of claim 1 wherein said providing said user access to said first computer system, comprises giving said user a user code and a password.

4. The method of claim 1 farther comprising said second computer system giving said first computer system a group of user ID's and passwords for use by said first computer system in accessing said second computer system.

5. The method of claim 4 wherein said user ID's are anonymous user IDs.

6. The method of claim 1 wherein when said user request for said service is for a local service of said plurality of services located in a same area as said user, said first computer system accesses a local computer system having said local service.

7. A service providing system for providing a service located on a service computer system to a user computer system, wherein said user computer system need only access said service providing system to obtain said service and wherein said service computer system is coupled to said service providing system via a communications network, said service providing system comprising:
a storage system;
an access table stored in a first part of said storage system, comprising a user identification for access to said service providing system by said user computer system;
a mapping table stored in a second part of said storage system, comprising said user identification and associated login information; and
responsive to a request by said user for said service, software stored in stored in a third part of said storage system, for accessing said service computer system using said associated login information and for obtaining said service for said user computer system.

8. The service providing system of claim 7 wherein said first part and second part of said storage system is a program memory.

9. The service providing system of claim 7 wherein said associated login information comprises an anonymous user login mapped to said user identification.

10. The service providing system of claim 7 wherein said user computer system comprises a device selected from a group consisting of a Personal Computer (PC), laptop, Personal Digital Assistant (PDA), cell phone, analog mobile phone, or workstation.

11. The service providing system of claim 7 wherein said service is in the same area as said user.

12. The service providing system of claim 7 wherein said computer system is a local to said user.

13. A distributed system for providing a plurality of services to a plurality of user computer systems, comprising:
a central server for providing a common access point for said plurality of user computer systems to said plurality of services;
a plurality of area servers coupled to said central server for providing information on local services of said plurality of services to local user computer systems of said plurality of user computer systems; and
a plurality of local cooperated company servers having said local services and coupled to said plurality of area servers; and
wherein a local user computer system of said plurality of user computer systems accesses said central server for a user request for a local service, said central server sends said request to a area server of said plurality of area servers, and said area server obtains said local service for said local user computer system.

14. The distributed system of claim 13 wherein said area server has a mapping of a local anonymous user to said local user for access to said local cooperated company server having said local service.

15. A data structure, including a table, stored in a computer readable medium for enabling a user to anonymously receive a service from a second service provider via a first service provider, said table comprising:
a first column entry in a row of said table comprising a user identification for said user, said user identification required for access to said first service provider;
a second column entry in said row of said table, having indentation information for said second service provider; and
a third column entry in said row of said table associated with said user identification and said indentation information for providing a predetermined user code for accessing said service on said second service provider.

16. The data structure of claim 15 wherein said predetermined user code is for an anonymous user.

17. The data structure of claim 15 wherein said predetermined user code is used by said first service provider to logon onto and receive said service from said second service provider on behalf of said user.

18. A computer readable medium for storing code for providing use by a user of a plurality of services through a common access point, comprising:
code for providing said user access to a first computer system;
code for said first computer system accessing a second computer system comprising said service in response to a user request for a service of said plurality of services,; and
code for providing said service to said user from said second computer system through said first computer system.

19. A service providing method for connecting a plurality of service providing systems to a service access system via a network, thereby enabling the plurality of the service providing systems to provide various services to the service access apparatus, the service providing method comprising:
sending display data including an indication for a service request issued to a second service providing system when said user selects said indication, said display data sent, when a service is provided to the service access system from a first service providing system;
enabling the service access apparatus to request a service of the second service providing system by the user selecting said indication from the display data displayed on the screen of the service access apparatus; and
starting communication between the service access apparatus and the second service providing system via the first service providing system, thereby providing the service of the second service providing system to the service access apparatus.

20. The service providing method of claim 19 further comprising:
enabling the service access apparatus to log in to said first service providing system with use of a predetermined user ID, thereby establishing communication between the service access apparatus and the first service providing system.

21. The service providing method of claim 19, further comprising the first service providing system logging into the second service providing system with a preset anonymous user ID before said starting communication between the service access apparatus and the second service providing system via the first service providing system.

22. A service providing system for providing various services to a service access apparatus via a network, the system comprising:
a means for sending display data including a selection button for a service request to a second service providing system, when a service is provided to the service access apparatus;
a means for establishing communication with the second service providing system when the selection button displayed on the screen of the service access apparatus is used; and
a means for communicating between the second service providing system and the service access apparatus so as to enable the second service providing system to provide the service to the service access apparatus via the first service providing system.
